(19) United States
(12) Patent Application Publication
(10) Pub. No.: US 2008/0125187 A1
(43) Pub. Date: May 29, 2008

(54) Wireless transmission system suitable for large space and method thereof

(76) Inventors: Yu-Chuan Chang, Taipei (TW); Ya-Hsun Hsu, Taipei (TW)

Correspondence Address: HARNESS, DICKEY & PIERCE, P.L.C., P.O. BOX 8910, RESTON, VA, 20195, US

(21) Appl. No.: 11/592,125

(22) Filed: Nov. 3, 2006

(51) Int. Cl. H04B 1/38; H04B 7/00; H04M 1/00

(52) U.S. Cl. 455/572; 455/522

(57) ABSTRACT

A wireless transmission system suitable for a large space and a method thereof are provided, which are applied to a wide space having a main power switch connected with power lines. Each of the power lines is respectively connected to a power outlet. A wireless base station is disposed beside the main power switch, and its required power is supplied by the main power switch. A signal line is respectively disposed along each power line, wherein one end of each signal line is connected to the wireless base station while the other end is connected to a wireless signal antenna. Each of the wireless signal antennas is respectively mounted on the corresponding power outlet. When wireless signals are sent from the wireless base station, they are transmitted via signal lines to anywhere in the wide space, and then sent out via the antennas to be received by mobile communication devices.

### BACKGROUND

1. Field of Invention

The present invention relates to a wireless transmission system and a method thereof, and more particularly, to a wireless transmission system suitable for large space and a method thereof.

2. Related Art

With the rapid development of the Internet, social people have become accustomed to and familiar with the network. No matter wired or wireless networks, they exist everywhere in daily life. However, due to the hustle and bustle of modern life, the development of wireless networks has become more and more important. A user can wirelessly log on the Internet for desired information via a mobile communication device, such as a personal digital assistant (PDA) or a notebook with wireless network card, in a location provided with wireless local area network.

However, the spatial scope of the wireless base station is somewhat limited. When a rather large space is provided with one wireless base station, not everywhere in the space can receive wireless signals. For example, one wireless base station is mounted on the ground floor of a commercial building, and users on the third floor or above may not be able to log on the internet; thus it is very inconvenient in the current society pervaded with mobile communication devices.

### SUMMARY

A main object of the invention is to provide a wireless transmission system suitable for large space and a method thereof, wherein signal lines are disposed beside each power line, such that the signals sent from a wireless base station can be transmitted via various signal lines to any location in a wide space, to solve the problem of the prior art.

Therefore, to achieve the above object, a wireless transmission system suitable for large space is provided by the present invention, which is applicable to a wide space. The wide space should have a main power switch connected with a plurality of power lines, wherein each of the power lines is respectively connected to a power outlet. The main power switch is mainly used to supply the required power for the wide space, and the power is transmitted via each power line to the corresponding power outlet to be used by the users. The wireless transmission system used for a wide space comprises a wireless base station, a plurality of signal lines, and a plurality of wireless signal antennas.

The wireless base station is used to send wireless signals, and is connected to the main power switch, wherein the main power switch supplies the required power to the wireless base station.

The plurality of signal lines are all connected to the wireless base station, wherein each of the signal lines is respectively disposed along each of the power lines, for transmitting the wireless signals sent by the wireless base station.

Each of the plurality of wireless signal antennas is respectively connected to one of the signal lines, that is, one signal line is connected to one wireless signal antenna. Each of the wireless signal antennas is respectively disposed on a corresponding power outlet, for receiving the wireless signals transmitted by the signal lines, and then sending them out to be received by mobile communication devices.

Also, a wireless transmission method suitable for large space is provided by the present invention, which is applicable to a wide space, such as a skyscraper. The wide space has a main power switch connected with multiple power lines, and the other end of each power line is connected to a power outlet, i.e., one power line is connected to one power outlet. The main power switch is used to supply the required power for the wide space, and the power is transmitted to each corresponding power outlet via each power line for usage.

In this method, first, a wireless base station is provided to be connected to the main power switch, wherein the main power switch supplies the demanded operation power to the wireless base station.

Next, the plurality of signal lines are provided. Each of the plurality of signal lines is connected to the wireless base station and is disposed along each of the power lines.

Then, the plurality of wireless signal antennas are provided. Each of the plurality of wireless signal antennas is respectively connected to each of the signal lines, and is respectively disposed on the corresponding power outlet.

Then, when the wireless base station sends wireless signals, the wireless signals sent from the wireless base station can be transmitted to each wireless signal antenna via each signal line. Finally, the wireless signals can be sent out via various wireless signal antennas, and then received by mobile communication devices.

The detailed features and advantages of the present invention are discussed in detail in the following embodiments. Any of those skilled in the art can easily understand and implement the technique content of the present invention. Furthermore, the relative objects and advantages of the present invention will be apparent to those skilled in the art from the content disclosed in the specification, claims, and drawings.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and which thus is not limitative of the present invention, and wherein:

FIG. 1 is a schematic view of a wireless transmission system suitable for large space according to the present invention; and

FIG. 2 is a flow chart of a wireless transmission method suitable for large space according to the present invention.

### DETAILED DESCRIPTION

To further understand the object, structure, features, and functions of the present invention, it will be illustrated in detail below through the embodiments. Besides, the above illustration of the content of the present invention and the following illustration of the embodiments are intended to demonstrate and explain the principle of the present invention, and to provide further explanation of the claims of the present invention.

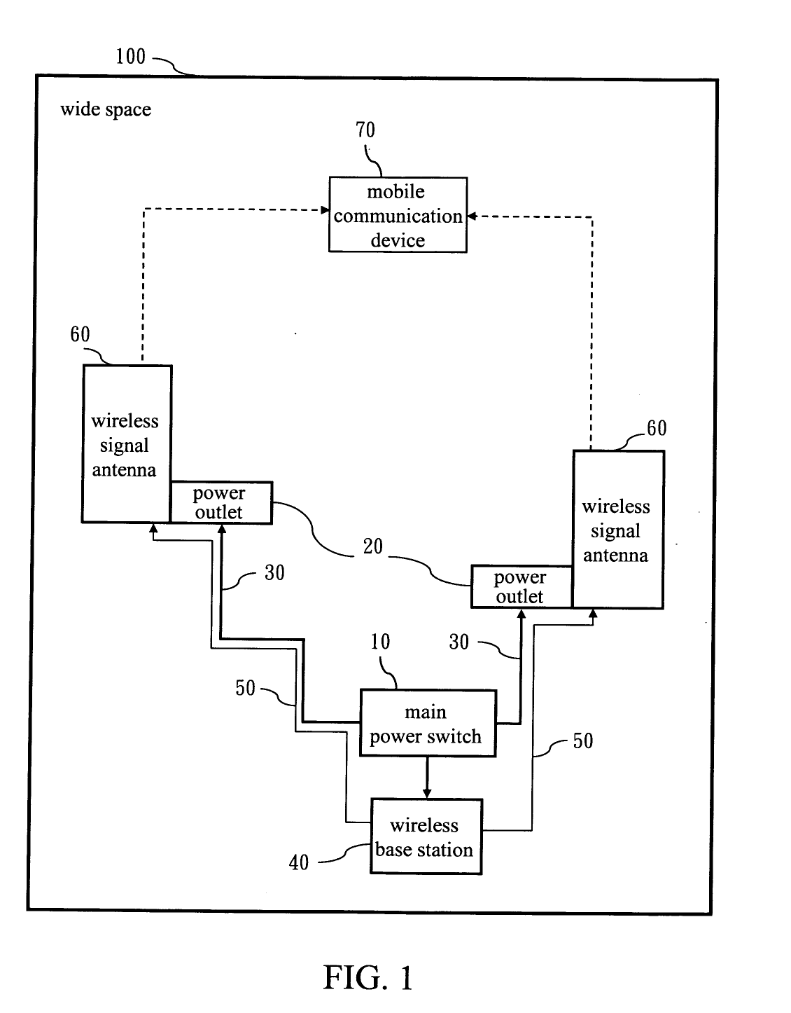

Please refer to FIG. 1 of a schematic view of a wireless transmission system suitable for large space according to the present invention. The system is applicable to a wide space 100, for example, a residential building or a commercial building. There is a main power switch 10 in the wide space 100, for example, a no-fuse breaker, for supplying the demanded power to any location in the wide space 100. A plurality of power lines 30 are connected to the main power switch 10, and the other end of each power line 30 is respectively connected to a power outlet 20. The distribution position of each power line 30 in the wide space 100 is designed through a calculated wiring layout, such that each power line 30 is uniformly distributed in the wide space 100, thereby achieving the most preferred effect and efficiency of power transmission. When applied to a commercial building, the power lines 30 should be uniformly distributed on each floor of the building. The main power switch 10 supplies the required power for the wide space 100, and the power can be transmitted to each corresponding power outlet 20 via each power line 30. Then, the user can plug electrical appliances into the power outlets 20 to be powered for usage. The wireless transmission system applicable to the wide space 100 comprises a wireless base station 40, multiple signal lines 50, and multiple wireless signal antennas 60.

The wireless base station 40 is used to send out wireless signals, and is connected to the main power switch 10 in the wide space 100. The main power switch 10 is required to supply power to the wireless base station 40 for operation. As the wireless base station 40 is disposed beside the main power switch 10, it is convenient for the signal lines 50 connected outwards from the wireless base station 40 to be disposed along the power lines 30.

As for the plurality of signal lines 50, each of the signal lines 50 is connected to the wireless base station 40, and the other end of each signal line 50 is connected to a wireless signal antenna 60. Each of the signal lines 50 is disposed along each of the power lines 30. As such, the signal lines 50 can be uniformly disposed everywhere on each floor of the wide space 10, just like the power lines 30. Therefore, the wireless signals sent out by the wireless base station 40 can be transmitted to any location in the wide space 10 via each signal line 50.

As for the plurality of wireless signal antennas 60, each of the wireless signal antennas 60 is connected to a signal line 50, and is disposed on the corresponding power outlet 20. The wireless signal antennas 60 receive the wireless signals transmitted by the signal lines 50, and then send out the wireless signals to be received by the mobile communication device 70, for example, a notebook computer with a wireless network card. Therefore, the user can wirelessly log on the internet at any floor of a building without being confined to the spatial scope around the wireless base station 40.

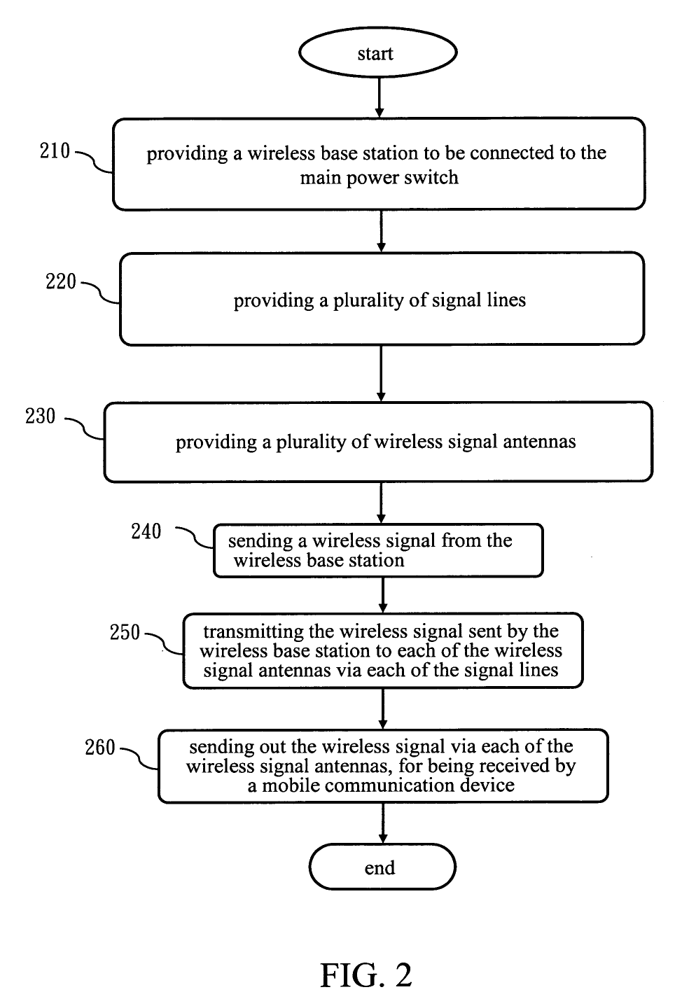

Please refer to FIG. 2 of a flow chart of a wireless transmission method suitable for a large space according to the present invention. The method is applicable to a wide space like a skyscraper. The wide space has a main power switch, for example, a no-fuse breaker, connected with a plurality of power lines, wherein the distribution position of each power line is designed according to a wiring layout, such that the power lines are uniformly distributed in the wide space. Each of the power lines is respectively connected to a power outlet. The main power switch is used to provide the required power for the wide space, and the power is transmitted to each corresponding power outlet via each power line for later usage.

In this method, a wireless base station is first provided to be connected to the main power switch, wherein the main power switch supplies the required power to the wireless base station for operation (Step 210). Then, a plurality of signal lines are provided to be connected to the wireless base station, and each of the signal lines is disposed along each of the power lines (Step 220). Then, a plurality of wireless signal antennas are provided to be respectively connected to each signal lines, and each of the wireless signal antennas is respectively disposed on the corresponding power outlets (Step 230). And then, the wireless base station sends out wireless signals (Step 240), and then the wireless signals sent by the wireless base station are transmitted to each wireless signal antenna via each signal line (Step 250). Finally, the wireless signals are sent out via each wireless signal antenna for being received by mobile communication devices (Step 260). As such, the user can use a notebook computer with a wireless network card to log on the Internet at any floor; therefore, it is very convenient.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A wireless transmission system applied to a wide space having a main power switch connected with a plurality of power lines, wherein each of the power lines is respectively connected to a power outlet; the main power switch is used to provide the required power for the wide space; and the power is transmitted to each corresponding power outlet via each of the power lines; the wireless transmission system comprising:
a wireless base station, for sending a wireless signal, and connected to the main power switch, wherein the main power switch supplies the required power to the wireless base station for operation;
a plurality of signal lines, connected to the wireless base station, wherein each of the signal lines is disposed along each of the power lines, for transmitting the wireless signal sent by the wireless base station; and
a plurality of wireless signal antennas, respectively connected to each of the signal lines, and respectively disposed on each of the corresponding power outlets, for receiving the wireless signal transmitted by each signal line, and then sending out the wireless signal received by a mobile communication device.

2. The wireless transmission system of claim 1, wherein the main power switch is a no-fuse breaker.

3. The wireless transmission system of claim 1, wherein the mobile communication device is a notebook computer.

4. The wireless transmission system of claim 1, wherein the distribution position of each power line in the wide space is designed through a wiring layout, such that each power line is uniformly distributed in the wide space.

5. A wireless transmission method applied to a wide space having a main power switch connected with a plurality of power lines, wherein each of the power lines is respectively connected to a power outlet; the main power switch is used to supply the required power for the wide space; and the power is transmitted to each corresponding power outlet via each of the power lines for usage, the wireless transmission method comprising:
providing a wireless base station connected to the main power switch, wherein the main power switch supplies the required power to the wireless base station for operation;
providing a plurality of signal lines, wherein each of the signal lines is connected to the wireless base station, and is disposed along each of the power lines;
providing a plurality of wireless signal antennas, wherein each of the wireless signal antennas is respectively connected to each of the signal lines, and is respectively disposed on each of the corresponding power outlets;
sending a wireless signal from the wireless base station;
transmitting the wireless signal sent by the wireless base station to each of the wireless signal antennas via each of the signal lines; and
sending out the wireless signal via each of the wireless signal antennas, for being received by a mobile communication device.

6. The wireless transmission method of claim 5, wherein the main power switch is a no-fuse breaker.

7. The wireless transmission method of claim 5, wherein the mobile communication device is a notebook computer.

8. The wireless transmission method of claim 5, wherein the distribution position of each of the power lines in the wide space is designed through a wiring layout, such that the power lines are uniformly distributed in the wide space.
